(19) United States
(12) Patent Application Publication
(10) Pub. No.: US 2012/0292924 A1
(43) Pub. Date: Nov. 22, 2012

(54) Door-Locking Device for Locking the Door of Household Appliance

(76) Inventors: Fabrizio Promutico, Torino (IT); Gianpaolo Barone, Torino (IT); Andrea Saccocci, Torino (IT)

(21) Appl. No.: 13/481,805

(22) Filed: May 26, 2012

Related U.S. Application Data
(63) Continuation of application No. PCT/IT2010/000426, filed on Oct. 21, 2010.

(30) Foreign Application Priority Data
Nov. 26, 2009 (IT) RM2009A000622

(51) Int. Cl. E05C 19/10

(52) U.S. Cl. 292/113

(57) ABSTRACT

A door-locking device for locking the door of household appliance, the door providing a closure hook, and at least a gasket provided on the door and/or on the household appliance. The device providing a locking hook, coupling with the household appliance closure hook, a slider, movable along a direction substantially parallel to the household appliance wall on which the door is provided, a lever compensating clearance of said gasket sealing closure, and kinematic means coupling the locking hook and the recovery lever, the locking hook being rotably coupled with said kinematic means and being movable according to a direction substantially perpendicular with respect to the movement direction of the slider, elastic means being further provided, aiming maintaining said kinematic means in a door closure position, and interaction means between the slider and the kinematic means for locking position each other in the door closure position.

### CROSS-REFERENCE TO RELATED APPLICATIONS

This application is a continuation of PCT/IT2010/000426 filed 21 Oct. 2010, which claims priority under 35 USC §119 to Italian Application No. RM2009A000622 filed Nov. 26, 2009.

The present invention relates to a door-locking device for locking the door of household appliance, particularly a washing machine.

More specifically, the invention relates to a door-locking device permitting compensating possible clearances due to gasket wearing and/or to stresses caused by household appliance operation.

As it is well known, the needing exist of having available a door-locking device for a washing machine permitting maintaining the washing machine door closed, by compensating closure clearances due for example to closure gasket deterioration caused by its ageing.

Furthermore, it exists the needing of having the possibility of compensating possible clearances of door closure when washing machine is working, particularly under full load conditions, said clearances causing problems since stresses of basket on the inner surface of the door can cause water leakage from gasket, and more generally deterioration of the quality of the same closure.

Different solutions have been suggested during recent years, all aiming solving this kind of problem.

However, even they can compensate the above clearances, none of the known solutions can provide a fully satisfying solution to the above mentioned needing.

In view of the above, the Applicant has realised and prepared a new door-locking device for the washing machine door that can satisfy all the above requirements, permitting a full recovery of possible clearances either due to gasket ageing or to stresses caused by full load washing machine operation.

It is therefore specific object of the present invention a door-locking device for locking the door of household appliance, said door providing a closure hook, and at least a gasket provided on said door and/or on said household appliance, said device being characterised in that it provides a locking hook, coupling with said household appliance closure hook, a slider, movable along a direction substantially parallel to the household appliance wall on which the door is provided, a lever compensating clearance of said gasket sealing closure, and kinematic means coupling said locking hook and said recovery lever, said locking hook being rotably coupled with said kinematic means and being movable according to a direction substantially perpendicular with respect to the movement direction of said slider, elastic means being further provided, aiming maintaining said kinematic means in a door closure position, and interaction means between said slider and said kinematic means for locking position each other in the door closure position.

Preferably, according to the invention, said device is provided with means for locking the same in the closure position, said locking means being de-activated only after de-activation of the household appliance operation.

Particularly, according to the invention, said locking means are comprised of a locking pin, acting on said slider.

Preferably, said kinematic connection between the lever hook is realised by a shaped element, providing on the front portion a seat for coupling the rotation hook and centrally a sliding seat for said slider.

Particularly, said interaction means between said slider and said kinematic means for locking the position each other in the door closure position are comprised of two projections provided on said slider and on said shaped element interacting in the different device operative steps.

Always according to the invention, said elastic means are comprised of a spring.

Still according to the invention, said locking hook rotates about a pin provided on said kinematic means, and it is provided above with an appendix slidably movable within a slot realised on said slider, and at the bottom with a slot for coupling with the door closure hook.

Preferably, said slot realised on said slider is longer than said appendix, so as to permit recovery of clearance.

In a preferred embodiment of the device according to the invention, mechanical means are provided for reducing angular stroke of the kinematic means when said locking means are active.

Preferably, according to the invention, said mechanical means are comprised of a relief on said slider, in order to reduce stroke of said mechanical means when said locking means are active, thus reducing maximum excursion of door movement when household appliance is operating, said relief reducing the angle of kinematic means that will be active only when said locking means is in an operative position.

Particularly, said relief has a triangular shape, and it is realised on said slider, being an integral part of the same by an elastic arm, permitting a rearward movement, on said kinematic means being it provided a angled shaped seat, having an inner surface able interacting with angled surface of triangular relief when said slider is in a forward position (door closed), or comprised of any other element carrying out the same function.

In a preferred embodiment of the device according to the invention, it comprises a hook, a slider, a clearance recovery lever, a spring and a locking pin, interacting with a corresponding seat realised under the slider, said lever being rotatably pivoted on a pin, provided on said base element, kinematic connection between hook and lever being realised by a shaped element, providing a coupling seat in the front portion for the rotation pin, and centrally a slider sliding seat, slider and shaped element being provided with two projections, interacting during the different steps of the device operation.

In lieu of the above mentioned relief, it can be provided every kind of mechanism permitting reducing the angular stroke of the shaped element (lever arm) when the locking pin is active.

The present invention will be now described, for illustrative, but not limitative purposes, according to a preferred embodiment, with particular reference to the enclosed drawings, wherein:

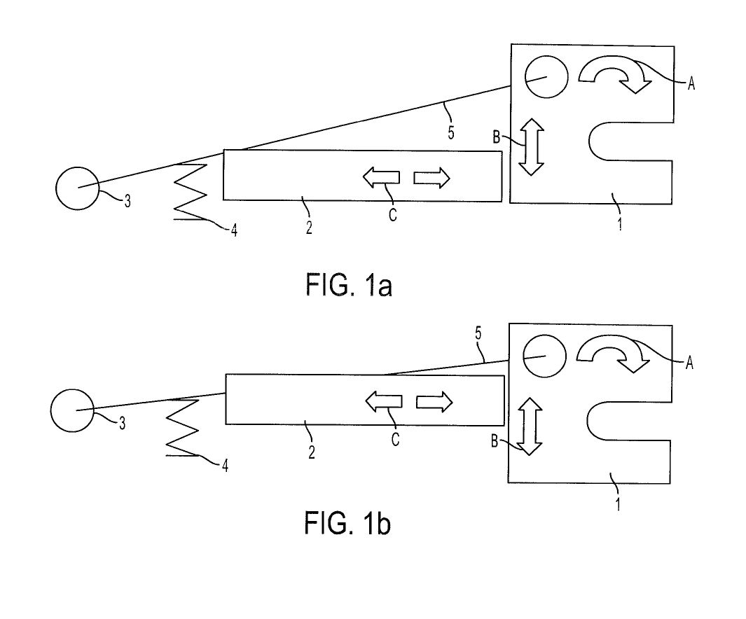

FIGS. 1a and 1b show the general scheme of the door-locking device according to the invention, respectively with the door closed and compensation of a more or less large clearance;

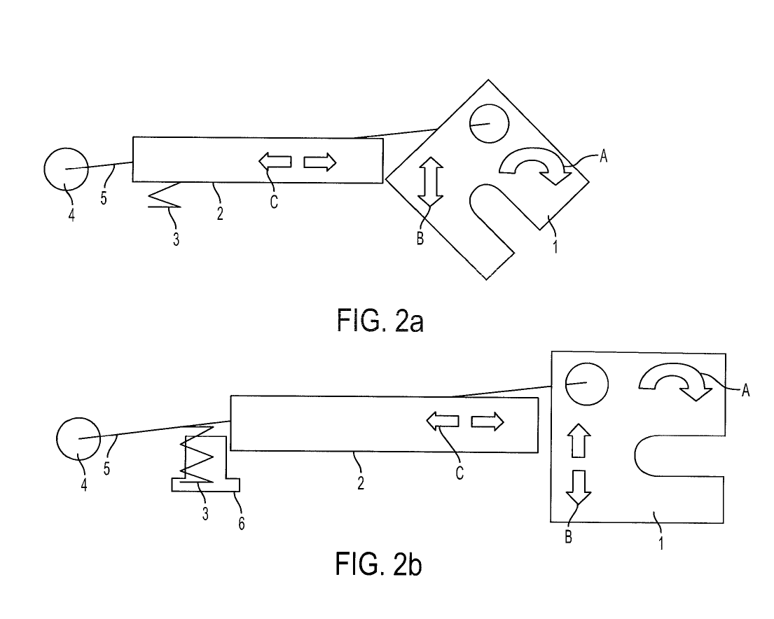

FIGS. 2a and 2b show scheme of FIG. 1, respectively in an opening condition and in an opening attempt, with the locking pin activated;

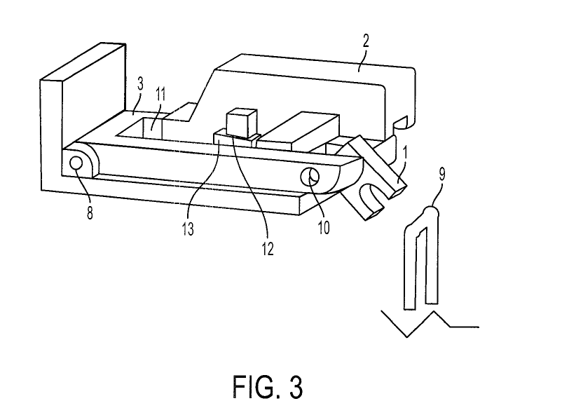

FIG. 3 generically shows a perspective view of a device according to the invention;

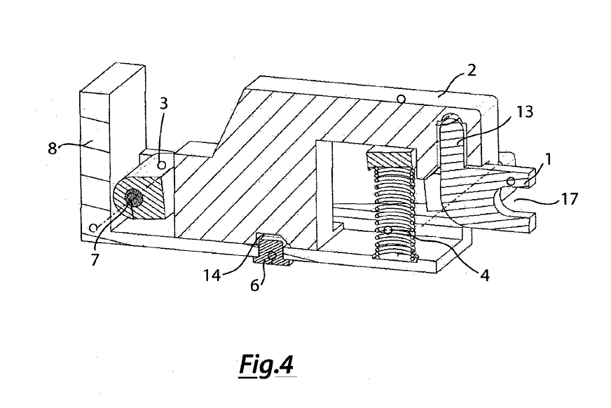

FIG. 4 is a vertical section longitudinal view of the device of FIG. 3, with the different components indicated;

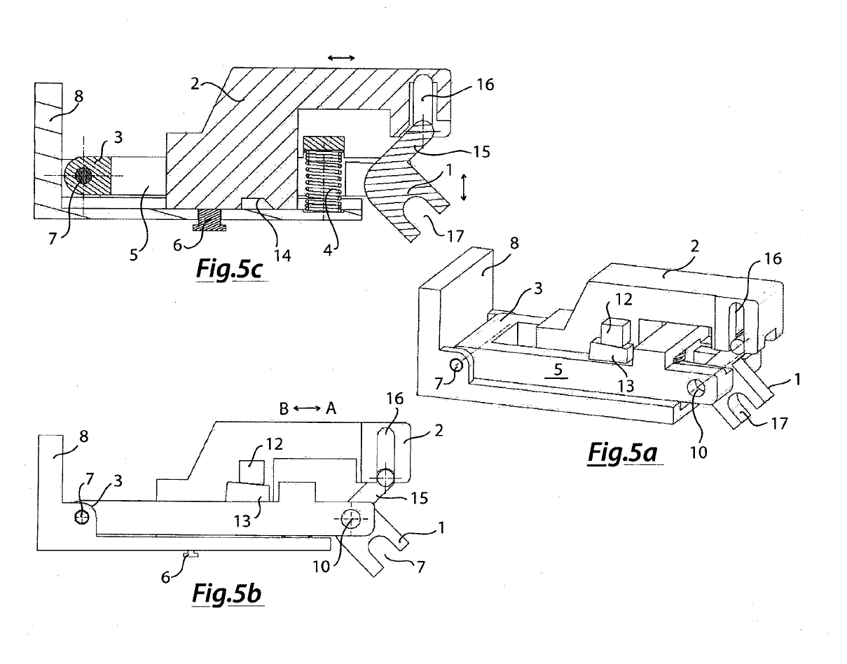

FIGS. 5a-5c respectively show, in a perspective, lateral and section view, of device according to the invention with the door open;

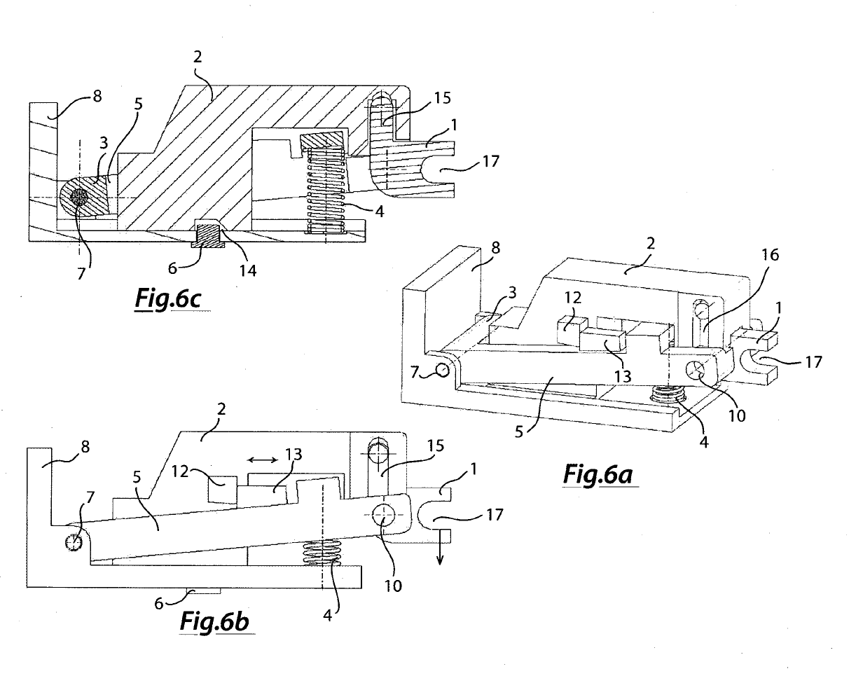

FIGS. 6a-6c respectively show, in a perspective, lateral and section view, of device according to the invention with the door locked;

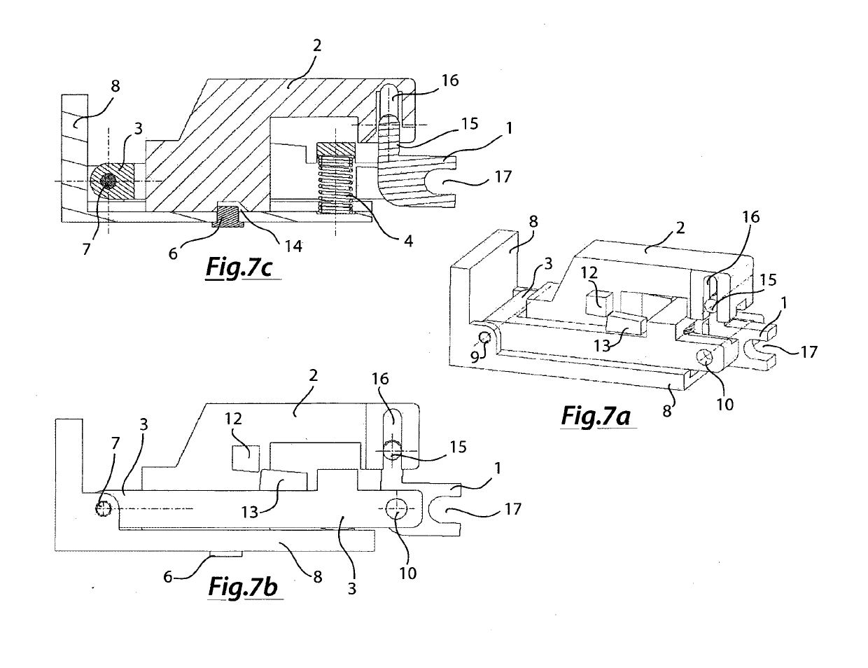

FIGS. 7a-7c respectively show, in a perspective, lateral and section view, of device according to the invention in an attempt of opening the door when the washing machine is operating; and

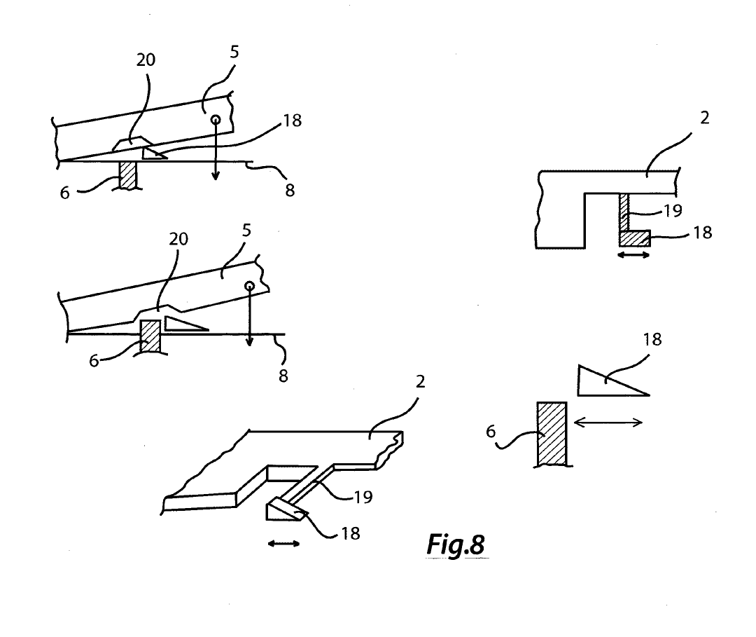

FIG. 8 shows a particular view of a preferred embodiment of the invention.

Observing first FIGS. 1 and 2, it is generically shown the operative principle of the door-locking device according to the invention.

In the various figures there are generically shown a hook 1, a slider 2, a buckling spring 4, a clearance recovery lever 5 and a mechanical coupling 4 between the hook 1 and the lever 5. Hook 1 is movable according to the direction of arrow A, during the door (not shown) closure and opening, and according to arrow B, for compensating clearances.

For example, FIGS. 1a and 1b show door-locking in a closure configuration, in two positions. The above puts into evidence that door-locking device can close (recovery) at different heights.

Slider 2 instead can move according to arrow C.

Spring 3 will be compressed when door is open and extended when door is closed. (Spring in every position acts to maintain recovery lever open, said spring could be a torsion or traction spring).

Operation of device according to the invention is shown in FIGS. 2a and 2b, respectively in an opening and closure position. Locking pin 6 is shown in FIG. 2b, preventing opening of door while household appliance is working.

Observing now the other figures of the enclosed drawings, and at first FIGS. 3 and 4, it is shown an embodiment of door-locking device according to the invention, providing hook 1, slider 2, clearance recovery lever 3, spring 4 and locking pin 6, interacting with a corresponding seat 14 realised under the slider 2.

Said lever 3 is pivoted on pin 7, supported by base element 8.

Kinematic coupling 5 between hook 1 and lever 3 is realised by a shaped element (generically indicated by reference number 5) providing a front seat 10 for coupling of hook 1 rotation pin and a central sliding seat 11 for slider 2.

By reference number 9 it is indicated door hook of washing machine (not shown).

Slider 2 and element 5 are provided with two projections, respectively indicated by reference numbers 12 and 13, interacting during the various operation steps, as it will be evident from the following specification.

Hook 1 rotates about pin 10 on element 5, and it is provided above with an appendix 15, sliding within a slot 16 realised on slider, and under provided with a hook 9 coupling slot 17.

Appendix 15 can move within slot 16 so as to permit its recovery.

Operation of door-locking device according to the invention will be described in the following.

Observing first FIG. 5, it is observed device according to the invention with door open. Hook 1 is free from coupling with hook 9 (not shown in this figure) of door. Two projections 12 and 13 are one above the other one. Spring 4 is compressed. Locking pin 6 does not interact with seat 14 and appendix 15 of hook 1 is substantially at one end of slot 16 of slider 2.

When door is closed (see particularly FIG. 6), hook 9 (not shown in this figure) of the door couples with hook 1 slot 17, making it rotating about pin 10. Appendix 15 slides within slider 2 slot 16, rising and forcing slider 2 to move, leftward in the figure, with respect to element 5.

During slider 2 movement, projection 12 moves sliding along projection 13, until freeing from the same. Now, spring 4 pushes element 5 upward, forcing the position of hook 1 with respect to slider 2.

While moving, slider 2 brings seat 14 in correspondence of locking pin 6, coupling with the same seat 14.

Kinematism comprised of hook 1, slider 2, element 5, lever 3 and spring 4 is such to permit hermetic closure of the door, recovering the clearance due to gasket wearing of stresses caused by operation.

In case someone attempts opening the door when washing machine is working (see FIG. 7), coupling between locking pin 6 and seat 14 is such to permit only a partial movement of hook 1, namely appendix 15 without permitting complete release.

Locking pin 6 is released only at the end of the washing cycle, when it will be possible opening the door.

Opening of the door is very easy. Acting on the door, it makes the hook 1 going downward, determining a sliding of slider rightward in the figure, with a consequent lowering of element 5 and interaction between two projections 12 and 13, and consequent compression of the spring 4.

Observing now embodiment of FIG. 8, a relief is provided on slider 2, aiming at reducing stroke of shaped element 5 of kinematism when locking pin 1 is in an active (raised) position, in order to reduce maximum stroke of door movement when washing machine is working, thus limiting recovery stroke.

Said relief 18 reduces angle between shaped element 5 (that can be indicated as the arm of lever 3), that will be active only when locking pin 1 is in an operative position.

In the embodiment shown in FIG. 8, relief 18 has a triangular shape and it is part of slider 2, being integral with the same by an elastic arm 19, permitting a rearward movement. Shaped element 5 has an angled shaped seat 20, having an inner surface that can interact with angled surface of triangular relief when slider 2 is in an advanced position (door closed). In such a condition, movement of triangular relief 18 is such to at least partly juxtapose on locking pin 6 when it is in a rest position.

When door hook 9 is engaged with locking hook 1, slider 2 is moved leftward on the sheet, and pin 6 is in a rest position. In case shaped element 5 (lever 3 arm) is stressed (dragged by door, opening of the door), angled shaped seat 14 interacts with triangular relief 18, pushing it backward (connection arm 19 is an elastic one), receiving it inside.

Thus, lever arm can even take a 0° angle with respect to the frame (or more generally, it can make the full stroke).

Under operative conditions, door hook 9 is engaged with locking hook 1, slider 2 is in position set in the above, but pin 6 is an operative position (outside). In case shaped element 5 (lever 3 arm) is stressed (always in a traction mode, opening attempt), shaped seat 20 interacts with triangular relief 18, trying pushing it backward, but pin 6 prevents its movement, so that triangular relief 18 interposes (acting as a thickness) itself between lever 3 arm and base element 8, thus reducing movement angular range (larger than) 0°.

Every other mechanism can be provided in lieu of the above relief, permitting reducing angular stroke of shaped element 5 (lever 3 arm) when locking pin 1 is active.

Present invention has been described for illustrative but not limitative purposes, according to its preferred embodiments, but it is to be understood that modification and/or variations can be introduced by those skilled in the art without departing from the relevant scope as defined in the enclosed claims.

1. Door-locking device for locking the door of household appliance, said door providing a closure hook, and at least a gasket provided on said door and/or on said household appliance, said device being characterised in that it provides a locking hook, coupling with said household appliance closure hook, a slider, movable along a direction substantially parallel to the household appliance wall on which the door is provided, a lever compensating clearance of said gasket sealing closure, and kinematic means coupling said locking hook and said recovery lever, said locking hook being rotably coupled with said kinematic means and being movable according to a direction substantially perpendicular with respect to the movement direction of said slider, elastic means being further provided, aiming maintaining said kinematic means in a door closure position, and interaction means between said slider and said kinematic means for locking position each other in the door closure position.

2. Door-locking device according to claim 1, characterised in that it is provided with means for locking the same in the closure position, said locking means being de-activated only after de-activation of the household appliance operation.

3. Door-locking device according to claim 2, characterised in that said locking means are comprised of a locking pin, acting on said slider.

4. Door-locking device according to claim 1, characterised in that said kinematic connection between the lever hook is realised by a shaped element, providing on the front portion a seat for coupling the rotation hook and centrally a sliding seat for said slider.

5. Door-locking device according to claim 4, characterised in that said interaction means between said slider and said kinematic means for locking the position each other in the door closure position are comprised of two projections provided on said slider and on said shaped element interacting in the different device operative steps.

6. Door-locking device according to claim 1, characterised in that said elastic means are comprised of a spring.

7. Door-locking device according to claim 1, characterised in that said locking hook rotates about a pin provided on said kinematic means, and it is provided above with an appendix slidably movable within a slot realised on said slider, and at the bottom with a slot for coupling with the door closure hook.

8. Door-locking device according to claim 7, characterised in that said slot realised on said slider is longer than said appendix, so as to permit recovery of clearance.

9. Door-locking device according to claim 1, characterised in that mechanical means are provided for reducing angular stroke of the kinematic means when said locking means are active.

10. Door-locking device according to claim 9, characterised in that said mechanical means are comprised of a relief on said slider, in order to reduce stroke of said mechanical means when said locking means are active, thus reducing maximum excursion of door movement when household appliance is operating, said relief reducing the angle of kinematic means that will be active only when said locking means is in an operative position.

11. Door-locking device according to claim 9, characterised in that said mechanical means are comprised of a mechanism permitting reducing angular stroke of the shaped element (lever arm) when the locking pin is active.

12. Door-locking device according to claim 11, characterised in that said relief has a triangular shape, and it is realised on said slider, being an integral part of the same by an elastic arm, permitting a rearward movement, on said kinematic means being it provided a angled shaped seat, having an inner surface able interacting with angled surface of triangular relief when said slider is in a forward position (door closed).

13. Door-locking device according to claim 1, characterised in that it comprises a hook, a slider, a clearance recovery lever, a spring and a locking pin, interacting with a corresponding seat realised under the slider, said lever being rotatably pivoted on a pin, provided on said base element, kinematic connection between hook and lever being realised by a shaped element, providing a coupling seat in the front portion for the rotation pin, and centrally a slider sliding seat, slider and shaped element being provided with two projections, interacting during the different steps of the device operation.
